(19) United States
(12) Patent Application Publication
(10) Pub. No.: US 2013/0246066 A1
(43) Pub. Date: Sep. 19, 2013

(54) METHOD AND APPARATUS FOR PROVIDING SERVICES USING VOICE RECOGNITION IN POS SYSTEM

(71) Applicant: POSBANK CO., LTD., Seoul (KR)

(72) Inventor: Jae Seob Choi, Gwangmyeong-shi (KR)

(73) Assignee: POSBANK CO., LTD., Seoul (KR)

(21) Appl. No.: 13/664,310

(22) Filed: Oct. 30, 2012

(30) Foreign Application Priority Data
Mar. 14, 2012 (KR) 10-2012-0025980

(51) Int. Cl. G10L 17/00; G06Q 20/40

(52) U.S. Cl. CPC G10L 17/005; G06Q 20/40
USPC 704/246

(57) ABSTRACT

A method of providing services using voice recognition in a POS system includes loading an execution command set for each service subject provided by the POS system for each group; registering item-based voice pattern information on the execution command for each group; detecting operation mode of the POS system and activating a microphone by driving voice recognition mode in response to the detected operation mode; converting the received signal of the activated microphone into digital data, detecting properties of a sound wave from the digital data, and extracting sound wave analysis data from the detecting properties; checking whether the sound wave analysis data has been registered and assigning a service use right to the received signal according to a result of the check; and performing voice recognition conversion on the received signal, searching for an execution command having a maximum likelihood for the resulting data, and performing services corresponding to the retrieved execution command.

### CROSS REFERENCE TO RELATED APPLICATION

This application claims the benefit of Korean Patent Application No. 10-2012-0025980, filed Mar. 14, 2012, which is hereby incorporated by reference in its entirety into this application.

### BACKGROUND OF THE INVENTION

1. Technical Field

The present invention relates to providing services in a Point Of Sales (POS) system using voice recognition.

2. Description of the Related Art

In general, in distribution and sales environments in which order service is performed, when an order is generated from a buyer, it is necessary to provide a variety of services, such as providing information through barcode recognition for a corresponding product depending on the type of order of the buyer, searching for products to be purchased by the buyer, providing settlement service for purchased products, accumulating mileage, and authenticating service beneficiary.

A Point Of Sales (POS) system, that is, a kind of order system that may be used in environments in which a large amount of distribution and sales service is performed has been very well received by people because rapid order processing can be computed.

In services using the existing POS system, however, even a user not having a service right to a corresponding POS system can easily access information on products and information on members when barcode recognition for the products has only to be performed. Accordingly, there are problems in that security for information is not guaranteed and accurate and rapid service environments are not provided because barcode recognition must be performed for each product in a sales environment in which distribution is performed in large quantities.

### SUMMARY OF THE INVENTION

Accordingly, the present invention has been made keeping in mind the above problems occurring in the prior art, and an object of the present invention is to provide technology for detecting the properties of a sound wave specific to a user from a voice signal received from the user in order to recognize an event that is generated in a POS system, analyzing the detected properties of the sound wave and comparing the detected properties of the sound wave with previously registered sound wave analysis data for each authenticated user, utilizing a result of the analysis and comparison as authentication data for assigning a service use right to the POS system, searching for an execution command having a maximum likelihood corresponding to the voice signal by performing voice recognition conversion on the voice signal, and performing service corresponding to the retrieved execution command.

In accordance with an aspect of the present invention, there is provided a method of providing services using voice recognition in a Point Of Sales (POS) system, including the steps of loading an execution command, set for each service subject that is provided by the POS system, for each group; registering information on a voice pattern corresponding to the execution command for each item for each of the loaded groups with a voice recognition engine registration unit; detecting operation mode of the POS system and activating a microphone by driving voice recognition mode in response to the detected operation mode; converting a signal, received through the activated microphone, into digital data, detecting properties of a sound wave from the converted digital data, and extracting sound wave analysis data for authenticating the received signal from the detecting properties; checking whether the extracted sound wave analysis data has been previously registered or not and assigning a service use right to the received signal according to a result of the check; and performing voice recognition conversion on the received signal, searching for an execution command having a maximum likelihood for the resulting data, and performing one or more services corresponding to the retrieved execution command.

In accordance with another aspect of the present invention, there is provided an apparatus for providing services using voice recognition in a Point Of Sales (POS) system, including a microphone; an Analog-to-Digital (A/D) converter unit configured to convert a signal, received from the microphone, into digital data; a voice recognition engine registration unit specialized to the POS system; a sound wave conversion unit configured to detect properties of a sound wave from the converted digital data and extract sound wave analysis data from the detected properties of the sound wave; and a control unit configured to detect operation mode of the POS system, activate the microphone by driving voice recognition mode in response to the detected operation mode, and perform control so that the A/D converter unit converts the signal, received through the activated microphone, into the digital data, the sound wave conversion unit detects the properties of the sound wave from the converted digital data and extracts the sound wave analysis data for authenticating the received signal from the detected properties of the sound wave, whether the extracted sound wave analysis data has been previously registered or not is checked, a service use right according to a result of the check is assigned to the received signal, and voice recognition conversion is performed on the received analog voice signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a method of providing services using voice recognition in a POS system in accordance with an embodiment of the present invention.

FIG. 2 is a detailed block diagram of an apparatus for providing services using voice recognition in a POS system in accordance with an embodiment of the present invention.

### DESCRIPTION OF THE PREFERRED EMBODIMENTS

Hereinafter, some exemplary embodiments of the present invention are described in detail with reference to the accompanying drawings. In the following description, specific items, such as elements, are illustrated, but they are provided to help overall understanding of the present invention. It is however evident to a person having ordinary skill in the art that the specific items may be modified or changed within the scope of the present invention.

The present invention relates to providing services using a Point Of Sales (POS) system and, more particularly, to technology for generating a member name, a product name, and a service name set for each service subject in the form of an execution command in order to recognize an event that is generated in the POS system, registering information on a voice pattern for the corresponding execution command with a voice recognition engine registration unit, detecting the properties of a sound wave specific to a user from a voice signal received from the user, analyzing the detected properties of the sound wave and comparing the detected properties of the sound wave with previously registered sound wave analysis data for each authenticated user, utilizing a result of the analysis and comparison as authentication data for assigning a service use right to the POS system, searching for an execution command having a maximum likelihood corresponding to the voice signal by performing voice recognition conversion on the voice signal, and performing service corresponding to the retrieved execution command.

The present invention provides technology for providing reliability of information security by allowing only an authenticated user to use POS system services using the specialized properties of personal voice, reducing an error rate and additional manpower occurring when performing product recognition using barcode one by one in an order system environment for the reduction of manpower and the improvement of work efficiency due to a reduced line of flow and for the prevention of an error in order particulars, and creating supplementary service for further activating distribution service through rapid processing of distribution and sales through voice recognition.

Furthermore, a POS system using voice recognition according to the present invention provides reliability to data obtained from the sound wave of a user and voice recognition not barcode when recognizing information on the subject to be checked, that is, a product, by using personally specialized voice in distribution and sales environments. Here, it is to be noted that the subject to be checked is not limited to only a product. Furthermore, the present invention relates to technology for extending a range of voice recognition by using the voice recognition engine registration unit in order to extend a recognition ratio of a product.

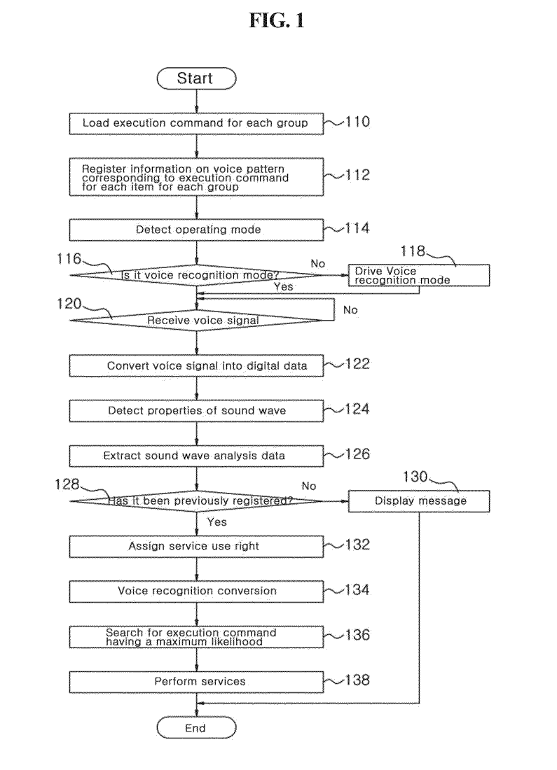

A method of providing services using voice recognition in a POS system in accordance with an embodiment of the present invention is described in detail with reference to FIG. 1.

FIG. 1 is a flowchart illustrating a method of providing services using voice recognition in a POS system in accordance with an embodiment of the present invention.

Referring to FIG. 1, first, at step 110, an execution command set for each service subject that is provided by the POS system is loaded for each group.

Here, the execution command set for each service subject is a default menu that has been previously set in a service range provided when the POS system is initially driven. The execution command can be set again in response to the signal of a user received through a microphone. The execution command means a product name, a service name, and a member name that can be identifier in the POS system. The execution command means voice that is pronounced as an item, for example, “Sawookang” or “Gamjachip”, of a group that has been classified as a predetermined keyword, for example, a snack species group when a user registers services while operating the POS system.

At step 112, information on a voice pattern for the execution command of each item for each of the loaded groups is registered with the voice recognition engine registration unit.

The voice recognition engine registration unit detects the characteristic vector of the received voice, recognizes the pattern, analyzes a morpheme, generates the corresponding voice into a sentence through processes, such as preliminary matching and sentence structure recognition, and stores the generated sentence.

At step 114, the operation mode of the POS system is detected. At step 116, whether the detected operation mode is voice recognition mode or not is determined. If, as a result of the determination, it is determined that the detected operation mode is voice recognition mode, whether a voice signal has been received or not through the microphone is determined at step 120.

In contrast, if, as a result of the determination at step 116, it is determined that the detected operation mode is not voice recognition mode, the POS system is driven in voice recognition mode at step 118.

If, as a result of the determination at step 120, it is determined that the voice signal has been received through the microphone, the analog voice signal received through the microphone is converted into digital data at step 122.

At this time, interference noise is eliminated from the converted digital data, and the data from which noise has been removed is amplified and outputted. If external noise included in the analog voice signal received through the microphone is severe, a subsequent voice waveform for the voice signal specialized to a person cannot be formed. Accordingly, the noise elimination process is necessary to precisely recognize corresponding sound wave analysis data by detecting the properties of a sound wave from the received analog voice signal.

At step 124, the properties of a sound wave are detected from the converted digital data.

Here, the sound wave analysis data has been previously obtained and registered in the form of a voice waveform consecutively interrupted and modulated from a waveform of voice in a cycle similar to the pitch cycle of the voice except the resonant component of the voice in order to modulate the specialized properties of voice for each authenticated user in the POS system. The sound wave analysis data is used to check whether the voice of a specific user received through the microphone has a service use right to the POS system. It is necessary to register voice for each authenticated user when the POS system is initially driven.

Next, at step 126, sound wave analysis data for authenticating the received analog voice signal is extracted. At step 128, whether the extracted sound wave analysis data has been previously registered or not is determined. If, as a result of the determination at step 128, it is determined that the extracted sound wave analysis data has been previously registered, a corresponding service use right is assigned to the received analog voice signal at step 132.

In contrast, if, as a result of the determination at step 128, it is determined that the extracted sound wave analysis data has not been previously registered, a message is displayed in order to preclude a service use right to the POS system.

At step 134, voice recognition conversion is performed on the received analog voice signal.

More particularly, symbols and letters formed by the voice recognition are matched, a result of the voice recognition is converted into a character string on the basis of a predetermined table, a predetermined key value is extracted from the converted character string, and a previously stored execution command is loaded based on the extracted key value.

At step 136, an execution command having a maximum likelihood for the resulting data is searched for. One or more services corresponding to the retrieved execution command are performed at step 138.

The one or more services are provided in such a manner that the sound wave analysis data extracted from the received analog voice signal is analyzed and compared with the previously registered sound wave analysis data, a service use right is assigned to the received analog voice signal if, as a result of the comparison, the extracted sound wave analysis data is identical with the previously registered sound wave analysis data, and the one or more services are provided in association with an object provided for each service server in response to an execution command corresponding to the voice recognition of the received analog voice signal. The object includes information on a specific product, product search service, an order, a member search, mileage accumulation, and settlement service corresponding to the execution command.

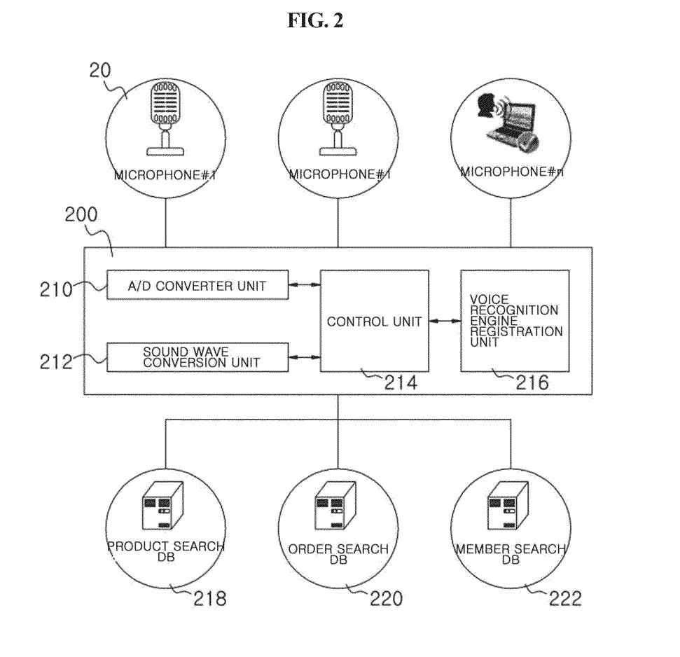

An apparatus for providing services using voice recognition in accordance with an embodiment of the present invention is described below with reference to FIG. 2.

FIG. 2 is a detailed block diagram of the apparatus for providing services using voice recognition in accordance with the embodiment of the present invention. The apparatus 200 for providing services using voice recognition to which the present invention is applied includes microphones 20, an Analog-to-Digital (A/D) converter unit 210, a voice recognition engine registration unit 216, a sound wave conversion unit 212, and a control unit 214.

The A/D converter unit 210 converts a signal received from the microphone 20 into digital data.

The voice recognition engine registration unit 216 detects the properties of a sound wave from the digital data of the A/D converter unit 210 and extracts sound wave analysis data from the detected properties of the sound wave.

The sound wave conversion unit 212 detects the properties of the sound wave from the digital data of the A/D converter unit 210 and extracts sound wave analysis data from the detected properties of the sound wave.

Here, the sound wave analysis data has been previously obtained and registered in the form of a voice waveform consecutively interrupted and modulated from a waveform of voice in a cycle similar to the pitch cycle of the voice except the resonant component of the voice in order to modulate the specialized properties of voice for each authenticated user in the POS system. The sound wave analysis data is used to check whether the voice of a specific user received through the microphone has a service use right to the POS system. It is necessary to register voice for each authenticated user when the POS system is initially driven.

The control unit 214 detects the operation mode of a corresponding POS system, activates the microphone 20 by driving voice recognition mode in response to the detected operation mode, and performs control so that the A/D converter unit 210 converts the signal, received through the activated microphone 20, into the digital data, the sound wave conversion unit 212 detects the properties of the sound wave from the converted digital data and extracts the sound wave analysis data for authenticating the received signal from the detected properties of the sound wave, whether the extracted sound wave analysis data has been previously registered or not is checked, a service use right according to a result of the check is assigned to the received signal, and voice recognition conversion is performed on the received analog voice signal.

Furthermore, the control unit 214 performs control so that the voice recognition engine registration unit 216 searches for an execution command having a maximum likelihood for the resulting data on which the voice recognition conversion has been performed and one or more services are provided in response to the retrieved execution command.

Here, the one or more services are provided in such a manner that the sound wave analysis data extracted from the received signal is analyzed and compared with the previously registered sound wave analysis data, a service use right is assigned to the received signal if, as a result of the comparison, the extracted sound wave analysis data is identical with the previously registered sound wave analysis data, and the one or more services are provided in association with an object provided for each service server in response to the execution command corresponding to the voice recognition of the received signal. The object includes information on a specific product, product search service, an order, a member search, mileage accumulation, and settlement service corresponding to the execution command. The services, as shown in FIG. 2, are provided by respective service servers 218, 220, and 222 which are associated with the apparatus for providing services using voice recognition to which the present invention has been applied.

Furthermore, the control unit 214 performs control so that symbols and letters formed by the voice recognition when performing the voice recognition conversion on the received signal are matched, a result of the voice recognition is converted into a character string on the basis of a predetermined table, a predetermined key value is extracted from the converted character string, and a previously stored execution command is outputted through the voice recognition engine registration unit 216 based on the extracted key value.

The present invention is advantageous in that it can provide reliability of information security by allowing only an authenticated user to use POS system services using the specialized properties of personal voice, reduce an error rate and additional manpower occurring when performing product recognition using barcode one by one in an order system environment for the reduction of manpower and the improvement of work efficiency due to a reduced line of flow and for the prevention of an error in order particulars, and create supplementary service for further activating distribution service through rapid processing of distribution and sales through voice recognition.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing services using voice recognition in a Point Of Sales (POS) system, the method comprising the steps of:
loading an execution command, set for each service subject that is provided by the POS system, for each group;
registering information on a voice pattern corresponding to the execution command for each item for each of the loaded groups with a voice recognition engine registration unit;
detecting operation mode of the POS system and activating a microphone by driving voice recognition mode in response to the detected operation mode;
converting a signal, received through the activated microphone, into digital data, detecting properties of a sound wave from the converted digital data, and extracting sound wave analysis data for authenticating the received signal from the detecting properties;
checking whether the extracted sound wave analysis data has been previously registered or not and assigning a service use right to the received signal according to a result of the check; and
performing voice recognition conversion on the received signal, searching for an execution command having a maximum likelihood for the resulting data, and performing one or more services corresponding to the retrieved execution command.

2. The method of claim 1, wherein the step of performing the voice recognition conversion comprises the steps of:
matching symbols and letters formed by the voice recognition and converting a result of the voice recognition into a character string based on a predetermined table; and
extracting a predetermined key value from the converted character string, loading a previously stored execution command corresponding to the extracted key value, and outputting the loaded execution command.

3. The method of claim 1, wherein the sound wave analysis data is previously obtained and registered in a form of a voice waveform consecutively interrupted and modulated from a waveform of voice in a cycle similar to a pitch cycle of the voice except a resonant component of the voice in order to modulate the specialized properties of voice for each authenticated user in the POS system.

4. The method of claim 1, wherein the received signal is obtained by eliminating interference noise from the converted digital data and amplifying the data from which the noise has been eliminated.

5. The method of claim 1, wherein the one or more services are provided in such a way as to analyze the sound wave analysis data extracted from the received signal, compare the analyzed sound wave analysis data with previously registered sound wave analysis data, assign a service use right to the received signal if, as a result of the comparison, the extracted sound wave analysis data is identical with the previously registered sound wave analysis data, and then provide the one or more services in association with an object provided for each service server in response to the execution command corresponding to the voice recognition of the received signal.

6. The method of claim 5, wherein the object comprises information on a specific product, product search service, an order, a member search, mileage accumulation, and settlement service corresponding to the execution command.

7. The method of claim 1, wherein:
the execution command set for each service subject is a default menu previously set when the POS system is initially driven, and
the execution command is set again in response to a signal of a user received through the microphone.

8. An apparatus for providing services using voice recognition in a Point Of Sales (POS) system, the apparatus comprising:
a microphone;
an Analog-to-Digital (A/D) converter unit configured to convert a signal, received from the microphone, into digital data;
a voice recognition engine registration unit specialized to the POS system;
a sound wave conversion unit configured to detect properties of a sound wave from the converted digital data and extract sound wave analysis data from the detected properties of the sound wave; and
a control unit configured to detect operation mode of the POS system, activate the microphone by driving voice recognition mode in response to the detected operation mode, and perform control so that the A/D converter unit converts the signal, received through the activated microphone, into the digital data, the sound wave conversion unit detects the properties of the sound wave from the converted digital data and extracts the sound wave analysis data for authenticating the received signal from the detected properties of the sound wave, whether the extracted sound wave analysis data has been previously registered or not is checked, a service use right according to a result of the check is assigned to the received signal, and voice recognition conversion is performed on the received analog voice signal.

9. The apparatus of claim 8, wherein the control unit performs control so that the voice recognition engine registration unit searches for an execution command having a maximum likelihood for the resulting data of the voice recognition conversion and provides one or more services corresponding to the retrieved execution command.

10. The apparatus of claim 8, wherein the control unit matches symbols and letters formed by the voice recognition when the voice recognition conversion is performed on the received signal, converts a result of the voice recognition into a character string based on a predetermined table, extracts a predetermined key value from the converted character string, and outputs a previously stored execution command through the voice recognition engine registration unit based on the extracted key value.

11. The apparatus of claim 8, wherein the sound wave analysis data is previously obtained and registered in a form of a voice waveform consecutively interrupted and modulated from a waveform of voice in a cycle similar to a pitch cycle of the voice except a resonant component of the voice in order to modulate the specialized properties of voice for each authenticated user in the POS system.

12. The apparatus of claim 8, wherein the voice recognition engine registration unit loads an execution command, set for each service subject provided by the POS system, for each group under the control of the control unit and registers information on a pattern of the execution command for each item for each of the loaded groups.

13. The method of claim 1, wherein the execution command comprises a product name, a service name, and a member name.
